(19) United States
(12) Patent Application Publication
(10) Pub. No.: US 2014/0153599 A1
(43) Pub. Date: Jun. 5, 2014

(54) METHOD AND DEVICE FOR OPERATING A LASER LIGHT SOURCE

(71) Applicants: Christoph DELFS, Bretten (DE); Ming LIU, Reutlingen (DE); Daniel KREYE, Reutlingen (DE)

(72) Inventors: Christoph DELFS, Bretten (DE); Ming LIU, Reutlingen (DE); Daniel KREYE, Reutlingen (DE)

(73) Assignee: ROBERT BOSCH GMBH, Stuttgart (DE)

(21) Appl. No.: 14/097,931

(22) Filed: Dec. 5, 2013

(30) Foreign Application Priority Data
Dec. 5, 2012 (DE) 10 2012 222 292.8

(51) Int. Cl. H01S 3/10

(52) U.S. Cl. CPC H01S 3/10
USPC 372/38.02

(57) ABSTRACT

A method for operating a laser light source including the steps: a) cyclically ascertaining an electrical voltage drop at the laser light source by energizing the laser light source; b) cyclically ascertaining a temperature of the laser light source from the ascertained electrical voltage drop with the aid of a first mathematical connection previously ascertained from the electrical voltage and the temperature of the laser light source; c) ascertaining a current which causes an essentially constant visual output of the laser light source for each ascertained temperature value with the aid of a second mathematical connection from the visual output and the current; and d) energizing the laser light source using this current.

### FIELD OF THE INVENTION

The present invention relates to a method and a system for operating a laser light source.

### BACKGROUND INFORMATION

Laser projectors having a micro-mirror unit for scanning a projection surface (scanning mirror laser projector) are known. The above-mentioned micro-mirror units will play an important role in projectors in the near future, in particular in miniaturized projectors for mobile devices (e.g., mobile phones, smart phones, notebooks, etc.). Among the different technologies which are used to form a pico-projector, laser scanning projectors offer some advantages, such as a small design and an increased efficiency due to the fact that laser light is emitted only when it is actually needed. The generated images are advantageously very bright due to the bright colors originating from the laser sources.

One known disadvantage of laser diodes used as laser light sources is their sensitivity to temperature changes, whereby visual output decreases with increasing operating temperature of the laser diodes. This may disadvantageously result in significantly reduced image qualities having falsified color schemes.

In particular, in some mobile devices having high brightness requirements, a self-heating effect of the laser diodes having limited capacity for heat dissipation exacerbates the display quality, e.g., also with regard to the brightness and the white balance, with increasing projection duration.

In order to compensate for this effect, a temperature change is typically detected and an operating current of the laser diode is accordingly adapted to achieve a coherence between the image data and the visual display. In the case that the brightness of the image is kept constant despite changing temperature, a projector may be operated closely to its performance limit.

United States Published Patent Appln. No. 2012/0044467 discloses principles of a projector based on laser light sources.

International Published Patent Appln. No. WO 2009/017895 A2 describes a model to determine a laser diode temperature which is based on preceding feed currents.

International Published Patent Appln. No. WO 2006/094590 A1 discloses an electrical circuit and a method for monitoring a temperature of a light-emitting diode.

There is a need for a laser diode having a visual output which is largely constant over its operating duration.

### SUMMARY

According to a first aspect, the present invention provides a method for operating a laser light source, the method having the following steps:
a) cyclically ascertaining an electrical voltage drop at the laser light source by energizing the laser light source;
b) cyclically ascertaining a temperature of the laser light source from the ascertained electrical voltage drop with the aid of a first mathematical connection, previously ascertained, between the electrical voltage and the temperature of the laser light source;
c) ascertaining a current which causes an essentially constant visual output of the laser light source for each ascertained temperature value with the aid of a second mathematical connection between the visual output and the current; and
d) energizing the laser light source using this current.

According to a second aspect, the present invention provides an activation device for a laser light source which is characterized in that the activation device has a compensation device, with the aid of which a current of the laser light source is adaptable to a changing temperature of the laser light source during an operation of the laser light source.

One preferred specific embodiment of the method provides that the method is carried out in a flyback phase of a laser beam of the laser light source. This provides the advantage of using a “dead time” for the laser beam, the compensation according to the present invention being carried out during this dead time. During this dead time, the laser beam is turned off, so that interferences cannot occur on the display.

Another preferred specific embodiment of the method according to the present invention provides that the flyback phase is a vertical flyback phase of the laser beam of the laser diode. In this way, the vertical dead time of the laser beam is used, this dead time having the advantage compared to the horizontal dead time that it is longer, thus providing more time for the temperature compensation according to the present invention.

Another preferred specific embodiment of the method according to the present invention provides that in step a), the current is below a threshold current of the laser light source. Here, the fact is advantageously used that there is no visual display on the projection surface, whereby a compensation is invisible for the user and the compensation is therefore carried out largely unnoticeably in the background.

Another preferred specific embodiment of the method according to the present invention provides that in step a), an intensity of the current is essentially constant and fixedly predefined. This advantageously makes it possible to ascertain the temperature of the laser light source in a simple manner due to a one-dimensional mathematical connection between a temperature and an electrical voltage at the laser light source. In this way, very precise results for the temperature may be additionally advantageously obtained.

One preferred specific embodiment of the method according to the present invention provides that the method is carried out in regular time intervals which are in the magnitude of seconds. Due to the fact that the temperature of the laser light source changes rather slowly during the operation, the temperature compensation does not have to be carried out very often either.

Another preferred specific embodiment of the method according to the present invention provides that an aging effect of the laser light source is taken into account, a new mathematical connection being ascertained in step a) between the electrical voltage and the temperature after a long operating duration. In this way, the aging effect of the laser light source may be advantageously taken into account which in principle results in an increased threshold current being necessary after many hours of operation (several thousand as a rule) for providing a constant visual output.

Another preferred specific embodiment of the method according to the present invention provides that the method is carried out separately for multiple laser light sources (1), the method being carried out consecutively for each laser light source. This offers the advantage that each laser diode may be compensated for individually, whereby a white balance is advantageously very balanced.

Another preferred specific embodiment of the method according to the present invention provides that the laser light source is a laser diode. This offers the advantage that a laser light source in the form of a laser diode benefits from the compensation according to the present invention. Since these laser light sources are very susceptible to the temperature variation effect, the present invention comes in particularly handy for the laser diodes.

One advantageous refinement of the activation device according to the present invention is characterized in that an electrical voltage drop, which is used to ascertain a temperature of the laser light source, is ascertainable at the laser light source with the aid of the compensation device, a current being settable for a constant visual output of the laser light source with the aid of the temperature. Advantageously, a mathematical connection between an electrical voltage and an operating temperature is utilized in this way to set an operating current of the laser light source.

Another preferred specific embodiment of the activation device according to the present invention is characterized in that multiple different laser light sources may be compensated for with the aid of the compensation device, a temperature compensation per color of the laser light source being compensable for in a different manner depending on the need. In this way, a good quality of the white balance of the laser light sources may be advantageously provided.

Another preferred specific embodiment of the activation device according to the present invention is characterized in that, with the aid of the activation device, a first laser light source is temperature-compensable in the form of a red laser diode, a second laser light source is temperature-compensable in the form of a green laser diode, and a third laser light source is temperature-compensable in the form of a blue laser diode. In this way, the method according to the present invention is specifically advantageously applied to different laser diodes, thus resulting in a high display quality due to the temperature-compensated laser diodes.

One particular advantage of the present invention is that a visual output of the laser diode may be essentially kept constant over its operating duration by compensating for a temperature effect. The method according to the present invention is characterized in that it is carried out in the background, so to speak, completely unnoticed by the user, whereby a usage quality of a projector is not impaired at all. The ascertainment of the voltage drop and the derivation or ascertainment of the temperature in the steps a) and b) advantageously take place in a time rhythm which corresponds to maximally one image cycle, but is carried out at least so many times that temperature changes to be expected between two measurements do not result in noticeably changed color effects.

Advantageously, the compensation according to the present invention for each laser light source is carried out separately, so that a constant white balance of all colors is obtained as a result.

Additional features and advantages of the present invention are elucidated in the following based on specific embodiments with reference to the drawings. All described or depicted features constitute the object of the present invention alone or in any arbitrary combination, irrespective of their summary in the patent claims or their back-reference as well as irrespective of their wording or depiction in the description or in the drawings. The drawings are primarily intended to illustrate the principles of the present invention. Identical reference numerals in the figures denote identical elements or elements having an identical function.

### BRIEF DESCRIPTION OF THE DRAWINGS

FIG. 1 shows a schematic configuration of a conventional laser scanning projector having three laser diodes.

FIG. 2 shows a schematic representation of a laser diode characteristic curve having a variation of a visual output variation against a current consumption at different temperatures.

FIG. 3 shows a schematic representation of a laser diode characteristic curve having a variation of an electrical voltage against the temperature at different feed currents.

FIG. 4 shows a schematic representation of a scanning frame of a laser diode on a visual display.

FIG. 5 shows a schematic representation of a design according to the present invention of an activation device for operating a laser diode.

FIG. 6 shows a schematic representation of a sequence of a specific embodiment of the method according to the present invention.

### DETAILED DESCRIPTION

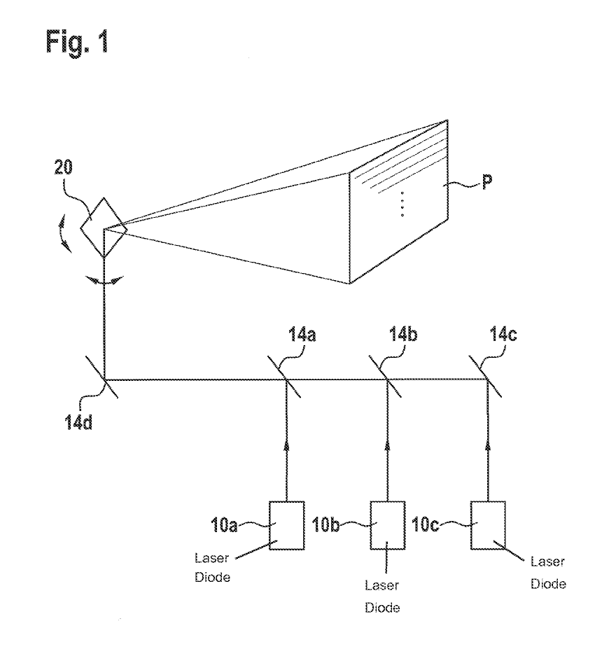

FIG. 1 shows a schematic view of a scanning laser projector or scanning projector in which the method according to the present invention may be used. A first laser diode 10a (e.g., a red laser diode), a second laser diode 10b (e.g., a green laser diode), and a third laser diode 10c (e.g., a blue laser diode) each emit a laser beam onto a reflective mirror 14a, 14b, and 14c in each case which directs a combined laser beam to a mirror 14d which directs the entire beam to at least one rotatable mirror 20. Rotatable mirror 20 may be designed as a 1-D system (having two mirrors rotatable about one axis each) or as a 2-D system (having one mirror rotatable about 2 axes). An image is generated on a projection surface P with the aid of a rotating movement of mirror 20. As long as a rotational position of mirror 20 is synchronous to a pixel content and a scanning rate, the user is able to see a complete image on projection surface P. The scanning projector may, for example, be situated within a mobile device (e.g., a mobile phone, a laptop, etc., not illustrated).

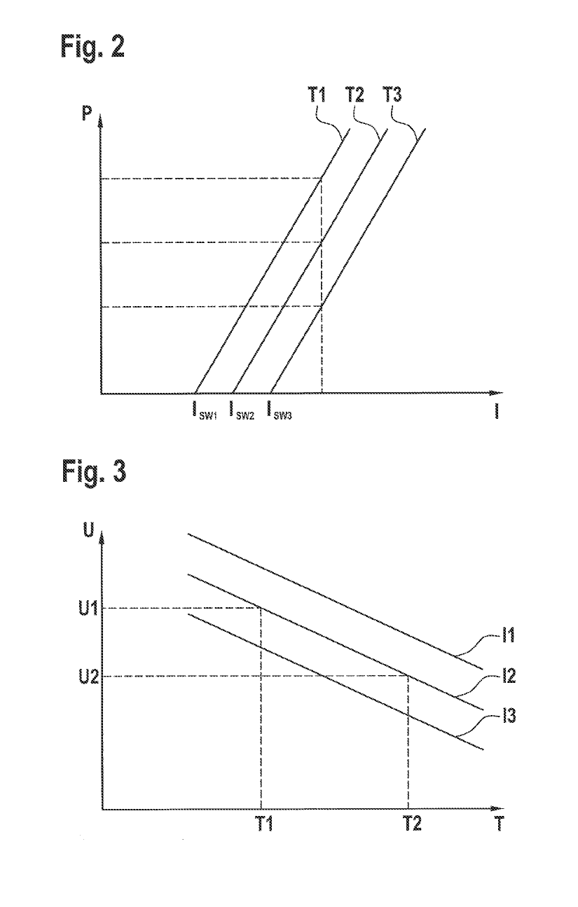

FIG. 2 qualitatively shows a sensitivity to temperature changes in above-mentioned laser diodes 10a, 10b, 10c. The figure shows here an x/y diagram, a visual output P of a typical laser diode being scaled on the y axis and a current consumption I of a typical laser diode being scaled on the x axis, regardless of their color spectrum. The three illustrated variations, which are essentially linear, represent a capacity of the laser diode at a low, a medium, or a high diode barrier layer temperature T1, T2, and T3, it being T1<T2<T3. It is apparent that a threshold current I_{SW1} . . . I_{SW3}, starting from which a laser diode 10a, 10b, 10c emits light noticeably, is a function of the temperature. Therefore, at a certain value of the threshold current, a visual output differs as a function of temperature T, as is recognizable from the dashed lines.

The visual output variation due to the temperature change ultimately results in an exacerbation of the image quality on the display or projection surface P. Initially, a display or projection surface brightness is reduced due to the self-heating effect of the laser diode or due to the changes in the surroundings temperature in the system. In addition, a performance ratio may vary between the colors due to the fact that there are intrinsic differences between red, blue, and green laser diodes, thus resulting in an impaired color scheme. A “white balance” is thus ultimately also exacerbated.

The subsequent mathematical equation describes the theoretical relationship between an electric current, an electrical voltage, and a temperature of a laser diode:

### Insert (1)

having the parameters:
I current through the laser diode
IS saturation reverse current
U electrical voltage drop at the diode (positive or negative)
   n barrier layer constant (typically 2 for diodes, 1 for transistors)
k Boltzmann constant
T temperature (in Kelvin)
q electron charge

According to the intrinsic characteristic of laser diodes, a value of the electrical voltage over the diodes decreases with the temperature and the feeding current, i.e., the following relationship results in the mathematical form:

U=f(T,I) (2)

FIG. 3 shows this dependence in a diagram using three different variations at different feed currents for the laser diode. It is apparent that electrical voltage U of the laser diode is, in a simplified manner, a linear function of the temperature of the diode barrier layer of the laser diode in the case of a fixed current value (e.g., I1, or I2, or I3), wherein the following applies: I1>I2>I3.

In most cases, this U-T variation is essentially linear or may be considered to be linear, having an acceptable error range for specific applications. Therefore, the operating temperature of the laser diodes may be derived from the measured forward voltage over the diode (T=g′(U)), as is disclosed in WO 2006/094590 A1, for example.

Temperatures T1 and T2 at the laser diode are, for example, derived from forward voltages U1 and U2 having a constant driver current I2, with reference to FIG. 3. In the case that it is not possible to keep the current constant in the event of temperature measurement, an additional parameter dimension may be introduced, thus resulting in a two-dimensional description in the following form:

T=h(U,I) (3)

Using the temperature information derived in this way, the visual output of laser diodes 10a, 10b, 10c may be kept essentially constantly stable with the aid of the variations of FIG. 2 by compensating for the threshold current. In the case that the variations shown in FIG. 2 for the different temperatures have strongly differing inclinations, it is also possible to compensate for this fact by setting a scaling register of a digital/analog converter for the output current.

The described compensation method is preferably carried out individually for each individual laser diode 10a, 10b, 10c. Advantageously, a white-balance issue of a complete laser module may be resolved in this way as long as the visual output of each individual color may be kept constant.

To be able to carry out a dynamic online temperature compensation, it is necessary to carry out an offline characterization in order to obtain already in advance the characteristics of the laser diode. The calibration procedure includes the following two steps in this case:

The first step describes the relationship between the temperature and the forward voltage in the case of a predefined, constant current, or between the temperature, the forward voltage, and the current. This step aims at obtaining the temperature information from the electrical measurements of the voltage and the current. When the compensation is carried out at a constant current, the T-U characterization is also be carried out at this constant current.

Otherwise, the characterization is carried out at varying currents, which, however, results in more complex T-U-I characterizations.

The second step aims at characterizing the visual output of laser diodes 10a, 10b, 10c in relation to the currents at different temperatures (see FIG. 2).

These two steps are used to compensate for a visual output of the laser diode during the operation, after the temperature of the laser diode has been derived from a voltage measurement in the first step.

The above-described method preferably also takes into account an aging effect of the laser diode. After a certain period of time (usually in the magnitude of several thousand hours), the visual output efficiency of laser diodes may be significantly reduced, the characteristics of the electrical voltage variations of the laser diodes also varying. As a result, the laser diode may be re-characterized in some applications after long operating durations to adapt the temperature compensation algorithm to the aging effect of the laser diode.

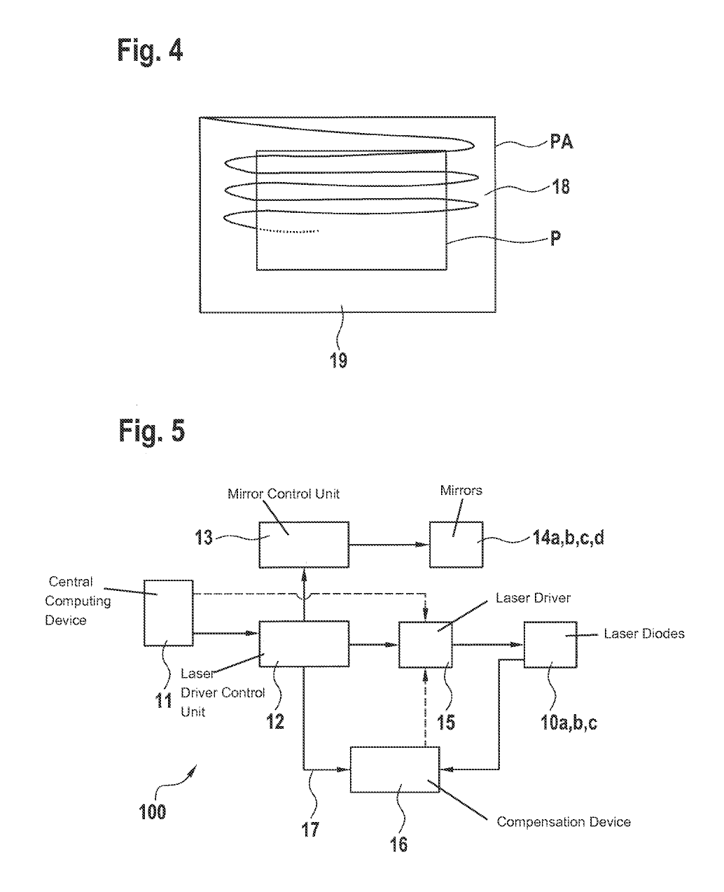

A practical implementation of the method is elucidated below with reference to FIGS. 4 and 5.

FIG. 4 schematically shows a scan window of the laser projector. PA is in this case the scanning region of the laser beam of the laser diode, only the “actual” effective projection surface P being visible for an observer. The remaining part is the so-called flyback region or flyback time, which is necessary to guide the laser beam of laser diodes 10a, 10b, 10c to the next line (horizontal flyback region 18) or to set it at the beginning of the subsequent image frame (vertical flyback region 19). No pixel is displayed in flyback regions 18, 19, after a feed current of the laser diode falls below the threshold current in the above-mentioned regions.

In order to not interfere with projection surface P, the described temperature compensation methods are preferably carried out in vertical flyback region 19. Advantageously, there is namely essentially more time available in vertical flyback region 19 to carry out the method according to the present invention, after an oscillation of vertical mirrors takes place (e.g., at approximately 60 Hz) which is essentially more low-frequency than an oscillation of horizontal mirrors (e.g., at approximately 20 kHz).

FIG. 5 shows a schematic hardware structure of an activation device 100 within a scanning projector using which the method according to the present invention may be carried out. A central computing device 11 (e.g., a CPU, GPU (graphical processing unit), etc.) supplies an image data flow to an image data line and laser driver control unit 12 which processes image frames and activates a laser driver 15 which activates laser diodes 10a . . . c. A mirror control unit 13 synchronizes with the image data line and controls the mechanical movement of mirrors 14. In this way, a certain pixel pattern may be reflected from mirror 14 in a correct position in the scanning region.

Compensation device 16 receives a synchronization signal from the image data line via a synchronization line 17 and thus signals a start of the flyback region and the forward voltage measurement to laser diodes 10a, 10b, 10c. After assigning the obtained forward voltage to the temperature information, laser driver 15 is set to the threshold value and the scaling registers in order to keep a visual output of laser diodes 10a, 10b, 10c constant despite the temperature change. This may be achieved either by central computing device 11 with the aid of software or by specific hardware devices, which is indicated in FIG. 5 with the aid of dashed lines.

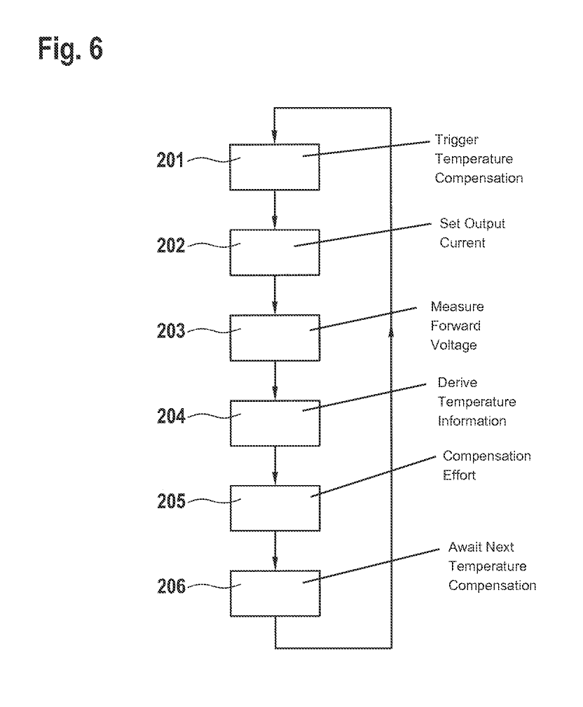

FIG. 6 shows a schematic sequence of a specific embodiment of the method according to the present invention in the form of a flow chart.

In a step 201, the temperature compensation is triggered at the beginning of the flyback region (preferably in vertical flyback region 19). This step requires time information to be transmitted with the aid of the image data line.

In a step 202, the output current, which is fed into laser diodes 10a, 10b, 10c during the temperature measurement, is set to a predefined value. This value is typically selected to be relatively low, preferably below a threshold current of laser diodes 10a, 10b, 10c, in order to not generate visible and disturbing interferences in the flyback region. A certain current may be achieved by temporarily setting the output DAC (consisting of threshold value DAC and color DAC, for example) in laser driver 15 or by central computing device 11, or by laser driver control unit 12, or with the aid of an autonomous laser driver 15, provided that laser driver 15 may receive the synchronization signal which displays the flyback region on the image data line.

Step 202 is optional and is only carried out if a fixed, predefined driver current for laser diodes 10a, 10b, 10c is provided for the application.

In a step 203, the forward voltage is measured over laser diodes 10a, 10b, 10c at a certain operating temperature of laser diodes 10a, 10b, 10c and may be obtained as a digital value.

In a step 204, the temperature information is derived under the characterization conditions from the measured voltage or from the measured voltage plus the diode current. The characterization conditions may be implemented in any practical, known form, e.g., as formulas, look-up tables, or as mathematical equations. In a step 205, a compensation effort may be determined for the threshold current of laser diodes 10a, 10b, 10c according to the characterization conditions. This compensation effort is added to the just fed threshold current which is supplied by laser driver 15, and the updated value is written in the laser driver threshold value DAC.

In order to prevent a blinking or flashing of projection surface P which originates from a sudden current change, the compensation is gradually applied to the threshold value DAC.

If necessary, the inclination of the visual output may be accordingly adapted in relation to the current variations at different temperatures by changing the scaling of the color DAC in laser driver 15.

In a step 206, it is awaited until the next temperature compensation must be carried out and a loop is restarted from the beginning. The entire procedure should usually not be repeated cyclically at an excessive frequency, since laser diodes 10a, 10b, 10c do not heat up too rapidly during operation in the case of suitable heat dissipation measures and the usual display patterns. For this reason, the temperature compensation during practical operation may be carried out, for example, after several 100 ms or even only after several seconds, in each case, whereby computing power may be advantageously saved. In a worst case scenario, it is also possible for the temperature compensation to be carried out for every single image, i.e., in every vertical flyback region.

The temperature compensation according to the present invention is specifically carried out in a system having multiple laser diodes for all laser diodes according to their primary colors.

To sum up, the present invention provides a device and a method which provide a systematic mechanism in order to mitigate a temperature dependence of a visual output of the laser diodes. The compensation is carried out periodically in the flyback region of the laser scanning projector, thus resulting in a minimum and invisible interference on projection surface P.

Compared to the conventional temperature compensation measures, e.g., an approach including fastening thermistors close to the laser diodes for the purpose of measuring the temperature, or photo sensors for recognizing changes in a visual output due to temperature changes, the proposed approach has the advantage that it does not need any type of external sensors and achieves few interferences on the projection surface as well as a more precise measurement and thus compensation. In contrast to conventional methods, the temperature compensation may thus be implemented using fewer components.

Although the present invention has been described with reference to preferred exemplary embodiments, it is not limited thereto. For example, it is also conceivable that the present invention may be applied to different light sources than the previously described laser diodes.

Those skilled in the art will therefore modify or combine the described features of the present invention in a suitable way, without departing from the essence of the invention.

What is claimed is:

1. A method for operating a laser light source, comprising:
a) cyclically ascertaining an electrical voltage drop at the laser light source by energizing the laser light source;
b) cyclically ascertaining a temperature of the laser light source from the ascertained electrical voltage drop with an aid of a first mathematical connection previously ascertained from the electrical voltage drop and the temperature of the laser light source;
c) ascertaining a current which causes an essentially constant visual output of the laser light source for each ascertained temperature value with an aid of a second mathematical connection from the visual output and the current; and
d) energizing the laser light source using the current.

2. The method as recited in claim 1, wherein the method is carried out during a flyback phase of a laser beam of the laser light source.

3. The method as recited in claim 2, wherein the flyback phase is a vertical flyback phase of the laser beam of the laser light source.

4. The method as recited in claim 1, wherein the current is below a threshold current of the laser light source in step a).

5. The method as recited in claim 1, wherein an intensity of the current is essentially constant and fixedly predefined in step a).

6. The method as recited in claim 1, wherein the method is carried out in regular time intervals which are in a magnitude of seconds.

7. The method as recited in claim 1, wherein an aging effect of the laser light source is taken into account, a new mathematical connection being ascertained in step a) between the electrical voltage drop and the current after a long operating duration of the laser light source.

8. The method as recited in claim 1, wherein the method is carried out separately for multiple laser light sources, the method being carried out consecutively for each laser light source.

9. The method as recited in claim 1, wherein the laser light source is a laser diode.

10. An activation device for a laser light source, comprising:
a compensation device, with an aid of which a current of the laser light source is adaptable to a changing temperature of the laser light source during an operation of the laser light source.

11. The activation device as recited in claim 10, wherein an electrical voltage drop, which is used to ascertain a temperature of the laser light source, is ascertainable at the laser light source with an aid of the compensation device, a current being settable for a constant visual output of the laser light source with an aid of the temperature.

12. The activation device as recited in claim 10, wherein multiple different laser light sources may be compensated for with the aid of the compensation device, a temperature compensation per color of the laser light source being compensable for in a different manner depending on the need.

13. The activation device as recited in claim 12, wherein, with an aid of the activation device, a first laser light source is temperature-compensable in the form of a red laser diode, a second laser light source is temperature-compensable in the form of a green laser diode, and a third laser light source is temperature-compensable in the form of a blue laser diode.

14. A computer program product having a program code for carrying out a method when the computer program product is executed on an electronic control unit or is stored on a computer-readable data carrier, the method being for operating a laser light source, and comprising:
a) cyclically ascertaining an electrical voltage drop at the laser light source by energizing the laser light source;
b) cyclically ascertaining a temperature of the laser light source from the ascertained electrical voltage drop with an aid of a first mathematical connection previously ascertained from the electrical voltage drop and the temperature of the laser light source;
c) ascertaining a current which causes an essentially constant visual output of the laser light source for each ascertained temperature value with an aid of a second mathematical connection from the visual output and the current; and
d) energizing the laser light source using the current.
